(19) United States
(12) Patent Application Publication
(10) Pub. No.: US 2015/0211372 A1
(43) Pub. Date: Jul. 30, 2015

(54) HOT ISOSTATIC PRESSING TO HEAL WELD CRACKS

(71) Applicant: SOLAR TURBINES INCORPORATED, San Diego, CA (US)

(72) Inventor: Jonathan Christopher Wilson, San Diego, CA (US)

(73) Assignee: SOLAR TURBINES INCORPORATED, San Diego, CA (US)

(21) Appl. No.: 14/168,923

(22) Filed: Jan. 30, 2014

(51) Int. Cl. F01D 5/14; B05D 3/12; B22D 25/02

(52) U.S. Cl. CPC F01D 5/147; B22D 25/02; B05D 3/12; F05D 2230/10; F05D 2230/90; F05D 2230/42

(57) ABSTRACT

A method of manufacturing a shrouded turbine blade is disclosed. In an embodiment, the method comprises casting a shrouded turbine blade including a shrouding. The shrouding includes an abutment face. The method includes welding a coating composed of a different material than the shrouded turbine blade onto the abutment face. The method includes applying hot isostatic pressing to the abutment face after welding the coating. The hot isostatic pressing is sufficient to heal internal defects in the abutment face. The method includes machining the shrouded turbine blade after applying hot isostatic pressing.

### TECHNICAL FIELD

The present disclosure generally pertains to gas turbine engines, and is more particularly directed toward a process for manufacturing gas turbine blades.

### BACKGROUND

Gas turbine engines include compressor, combustor, and turbine sections. Turbine blades of a gas turbine engine are subject to high temperatures. In particular, turbine blades undergo considerable wear during operation and may require repair for continued use. Certain methods and processes may be performed during manufacture of the turbine blades to reduce the need for future repair.

U.S. Pat. No. 5,951,792 to W. Balbach et al. discloses a method for welding age-hardenable nickel-base alloys. A workpiece made from an age-hardenable nickel-base alloy is welded from filler material of the same composition as the base material. The weld metal which is formed in so doing is covered by a sealed covering layer comprising a ductile material and the workpiece is subjected to hot isostatic pressing (HIP).

The present disclosure is directed toward overcoming one or more of the problems discovered by the inventors.

### SUMMARY OF THE DISCLOSURE

A method of manufacturing a shrouded turbine blade is disclosed. In an embodiment, the method comprises casting a shrouded turbine blade including a shrouding. The shrouding includes an abutment face. The method includes welding a coating composed of a different material than the shrouded turbine blade onto the abutment face. The method includes applying hot isostatic pressing to the abutment face after welding the coating. The hot isostatic pressing is sufficient to heal internal defects in the abutment face. The method includes machining the shrouded turbine blade after applying hot isostatic pressing.

### BRIEF DESCRIPTION OF THE DRAWINGS

FIG. 1 is a schematic illustration of an exemplary gas turbine engine.

FIG. 2 is a cross sectional view of a portion of the gas turbine engine turbine of FIG. 1.

FIG. 3 is a perspective view of an embodiment of a single shrouded turbine blade.

FIG. 4 is a perspective view of a portion of an embodiment of a shrouded turbine blade.

FIG. 5 is a perspective view of a portion of the shrouded turbine blade of FIG. 4 after welding a coating to an abutment face.

FIG. 6 is a perspective view of a portion of the shrouded turbine blade of FIG. 4 after applying hot isostatic pressing to an abutment face.

FIG. 7 is a perspective view of a portion of the shrouded turbine blade of FIG. 4 after machining an abutment face.

FIG. 8 is a flow chart of an embodiment of a manufacturing process.

### DETAILED DESCRIPTION

The systems and methods disclosed herein include a method for manufacturing a shrouded turbine blade. The shrouded turbine blade may be used in a gas turbine engine including a turbine section. The method may include casting a shrouded turbine blade including a shrouding. The shrouding may be attached to an airfoil of the shrouded turbine blade, and may also include an abutment face. The method may include welding a coating composed of a different material than the shrouded turbine blade onto the abutment face. The method may include applying hot isostatic pressing to the abutment face after welding the coating. The hot isostatic pressing may be sufficient to heal internal defects in the abutment face. The method may include machining the shrouded turbine blade after applying hot isostatic pressing.

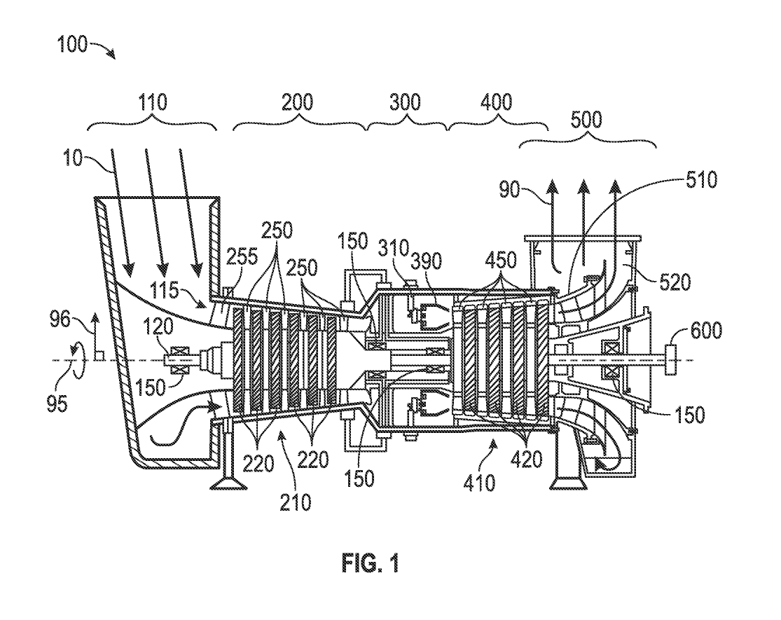

FIG. 1 is a schematic illustration of an exemplary gas turbine engine. Some of the surfaces have been left out or exaggerated (here and in other figures) for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from, wherein a radial 96 may be in any direction perpendicular and radiating outward from center axis 95.

A gas turbine engine 100 includes an inlet 110, a shaft 120, a gas producer or “compressor” 200, a combustor 300, a turbine 400, an exhaust 500, and a power output coupling 600. The gas turbine engine 100 may have a single shaft or a dual shaft configuration.

The compressor 200 includes a compressor rotor assembly 210 and compressor stationary vanes (“stators”) 250. The compressor rotor assembly 210 mechanically couples to shaft 120. As illustrated, the compressor rotor assembly 210 is an axial flow rotor assembly. The compressor rotor assembly 210 includes one or more compressor disk assemblies 220. Each compressor disk assembly 220 includes a compressor rotor disk that is circumferentially populated with compressor rotor blades. Stators 250 axially precede each of the compressor disk assemblies 220. Each compressor disk assembly 220 paired with the adjacent stators 250 that precede the compressor disk assembly 220 is considered a compressor stage. Compressor 200 includes multiple compressor stages.

The combustor 300 includes one or more injectors 310 and includes one or more combustion chambers 390.

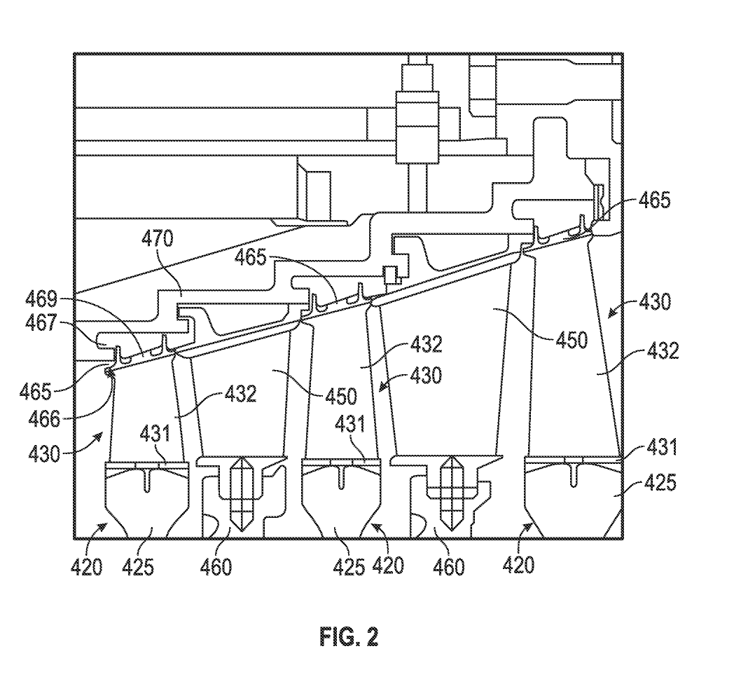

Certain aspects of the turbine rotor assembly will be described with reference to FIG. 1 and with reference to FIG. 2. FIG. 2 is a cross-sectional view of a portion of the turbine 400 of FIG. 1. All references to radial, axial, and circumferential directions and measures for elements of turbine disk 425 refer to the axis of turbine disk 425, which is concentric to center axis 95. The turbine 400 includes a turbine rotor assembly 410, turbine nozzles 450, one or more turbine diaphragms 460, and one or more turbine disks 425. The turbine rotor assembly 410 mechanically couples to the shaft 120. As illustrated, the turbine rotor assembly 410 is an axial flow rotor assembly. The turbine rotor assembly 410 includes one or more turbine disk assemblies 420. Each turbine disk assembly 420 includes a turbine disk 425 that is circumferentially populated with shrouded turbine blades 430. Each shrouded turbine blade 430 may include a shrouding 465. Turbine nozzles 450 axially precede each of the turbine disk assemblies 420. The turbine diaphragm 460 may support turbine nozzles 450 and may be located radially inward from turbine nozzles 450. The exhaust 500 includes an exhaust diffuser 510 and an exhaust collector 520. The power output coupling 600 may be located at the end of shaft 120.

As illustrated in FIG. 2, each shrouded turbine blade 430 may include a blade platform 431 and an airfoil 432. The airfoil 432 extends radially outward from the blade platform 431. Shrouded turbine blades 430 may be installed axially or circumferentially onto each turbine disk 425. Each shrouding 465 may be located radially between turbine housing 470 and airfoil 432. Shrouding 465 may be formed as part of each shrouded turbine blade 430. In some embodiments, shrouding may be a separate component adjacent and detached from the shrouded turbine blade (not shown).

One or more of the above components (or their subcomponents) may be made from a base material that is stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance.

Superalloys may include materials such as alloy x, WASPALOY, RENE alloys, alloy 188, alloy 230, INCOLOY, INCONEL, MP98T, TMS alloys, and CMSX single crystal alloys.

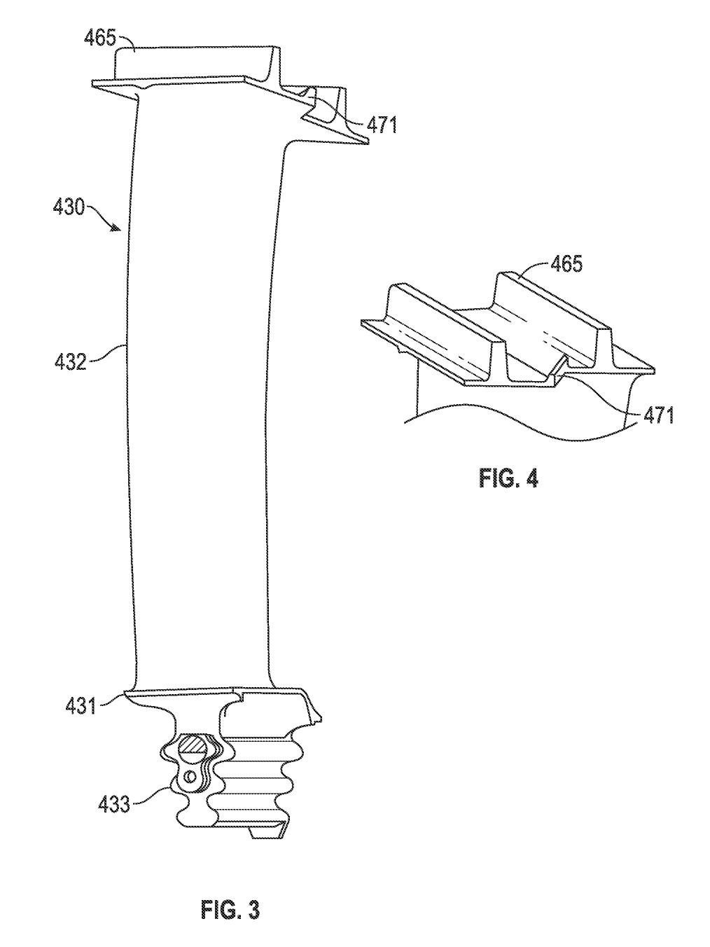

FIG. 3 is a perspective view of an embodiment of a shrouded turbine blade 430. The bottom of the airfoil 432 may be connected to the blade platform 431. A tip end of the airfoil 432, distal from the blade platform 431, may be located adjacent to the shrouding 465. The blade root 433 extends radially inward from the blade platform 431 and connects the shrouded turbine blade 430 to the turbine disk 425. The bottom of the blade platform 431 may be connected to the blade root 433. Blade root 433 may be installed into each turbine disk 425 (not shown).

FIG. 4 is a perspective view of an embodiment of shrouding 465. In particular, this figure shows an abutment face 471 that is located on the side of the shrouding 465. An abutment face 471 may be located on both sides of the shrouding 465 (not shown). The abutment face 471 may be at an angle and configured to interface with an abutment face of an adjacent shrouded turbine blade. In some embodiments, a plurality of shrouded turbine blades may be installed circumferentially around a turbine disk, wherein each shrouded turbine blade may interlock with adjacent shrouded turbine blades at adjacent abutment faces to form a continuous annular surface.

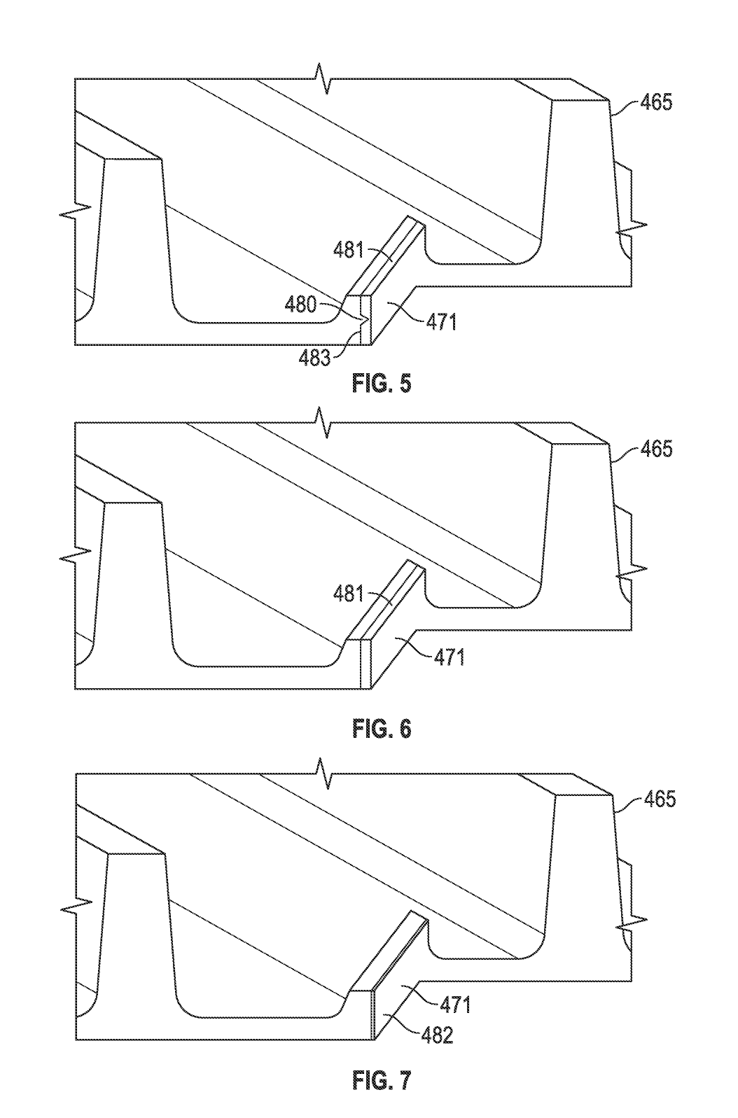

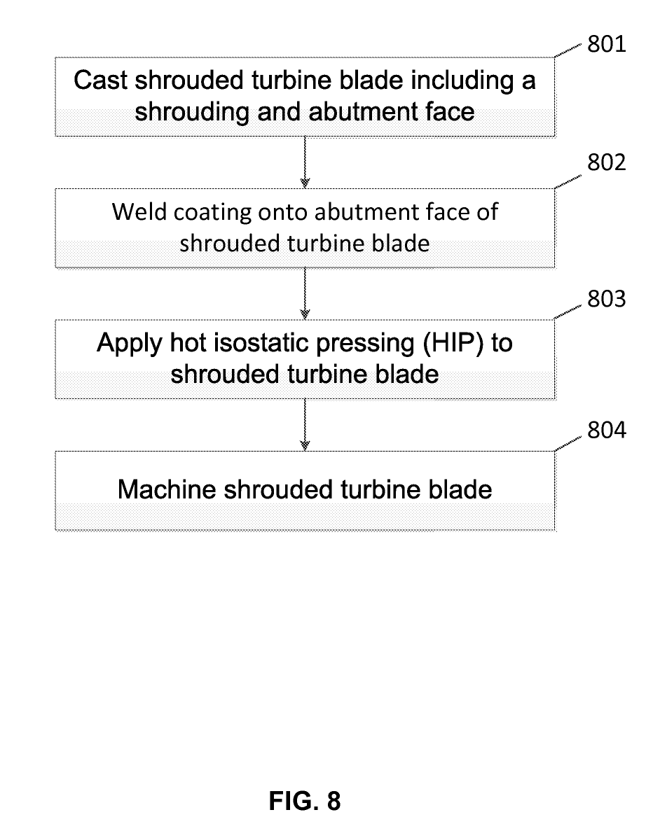

FIG. 5, FIG. 6, and FIG. 7 depict a sequential progression of a process of manufacturing a shrouded turbine blade. In some embodiments, FIG. 5-7 follows a sequential progression according to an embodiment of the process shown in FIG. 8. Some of the edges and surfaces depicted in these figures have been exaggerated for clarity and easy of explanation.

FIG. 5 depicts a portion of the shrouded turbine blade of FIG. 4, in which the abutment face 471 of the shrouding 465 includes a weld coating 481. The weld coating 481 may be bonded to the abutment face 471 by welding, cladding, or other similar techniques. The weld coating 481 may sometimes be referred to as a hardface, and may form a hard exterior surface. The weld coating 481 may be composed of a material different than the base material of the shrouded turbine blade. In some embodiments, the composition of the weld coating 481 may include one or more of the following materials: cobalt, nickel, tungsten, chromium, molybdenum, steel, and aluminum. In a preferred embodiment, the weld coating 481 adds a protective layer around the abutment face 471. This may protect the abutment face 471 from heavy loading and high pressures. The abutment face 471 may undergo considerable wear, especially when positioned adjacent other abutment faces of other shrouded turbine blades. As such, the weld coating 481 may decrease the friction coefficient of the surface of the abutment face 471, and may allow for more wear. In some embodiments, the weld coating 481 may be applied to include a build up of excess material around the abutment face 471.

As shown in FIG. 5, an internal crack 480 may be located between the weld coating 481 and the abutment face 471. For example, internal crack 480 may be a crack in the abutment face edge 483. The internal crack 480 may be exaggerated for clarity and ease of explanation. The internal crack 480 may be a defect located anywhere within the bonding of the weld coating 481 and abutment face 471. In such instances, the internal crack 480 may be formed as a result of the dissimilar materials of the weld coating 481 and the abutment face 471.

FIG. 6 depicts the portion of the shrouded turbine blade of FIG. 5 after applying hot isostatic pressing. As a result of hot isostatic pressing, internal crack 480 may be healed. This may be a result of decreasing the porosity and increasing the density of the metal in the abutment face 471 due to the hot isostatic pressing.

FIG. 7 depicts the portion of the shrouded turbine blade of FIG. 6 after machining the abutment face 471. Machining the abutment face 471 may remove excess weld coating material and result in machined surface 482. As seen in FIG. 7, machined surface 482 may be closer to abutment face 471.

### INDUSTRIAL APPLICABILITY

Gas turbine engines may be suited for any number of industrial applications such as various aspects of the oil and gas industry (including transmission, gathering, storage, withdrawal, and lifting of oil and natural gas), the power generation industry, cogeneration, aerospace, and other transportation industries.

Turbine blades are subject to high stress and defects in the blade due to high operating temperatures. In embodiments with a shrouding, the shrouding in particular may reach the maximum velocity of the turbine blade and thus may be subject to the highest stress. Turbine blades are often routinely serviced to repair defects found internally and/or on the surface of the turbine blade. Such repair may be costly and time consuming.

FIG. 8 is a flowchart of a process for manufacturing shrouded turbine blades. In some embodiments, the process may produce shrouded turbine blades which require less repair service over their lifetime. The process begins at Step 801 where the shrouded turbine blade is cast. The shrouded turbine blade may include a shrouding, in which the shrouding includes an abutment face. The process includes a Step 802, where a weld coating may be applied onto the abutment face of the shrouded turbine blade. The weld coating may be composed of a different material than the shrouded turbine blade. In a Step 803, hot isostatic pressing (HIP) may be applied to the shrouded turbine blade. In some embodiments, HIP may be applied sufficient to heal internal defects in the abutment face. In a Step 804, the shrouded turbine blade may be machined to remove defects in the shrouded turbine blade, as well as remove excess weld material in the weld coating.

In some embodiments, casting in Step 801 may be performed via a multitude of casting methods including, but not limited to, die casting, investment casting, centrifugal casting, continuous casting, and permanent mold casting. In embodiments where the shrouded turbine blade is casted by investment casting, a ceramic mold may be created from a wax mold. The wax mold may be melted and replaced with molten metal to form the shrouded turbine blade. Die casting, on the other hand, involves forcing molten metal under high pressure into a mold cavity, wherein the mold cavity consists of two hardened tool steel dies machined to a particular shape. During the casting process, varying types of casting defects may arise. Casting defects may include shrinkage defects, gas bubbles, porosity, misruns, cold shuts, tears, and spots. Casting defects may be detected by conventional surface crack detection methods. In some instances, sectioning of the shrouded turbine blade may be used to detect internal defects, particularly in heat affected zones of the shrouded turbine blade. An example of a casted shrouded turbine blade including a shrouding with an abutment face is shown in FIG. 4.

In some embodiments, welding the weld coating in Step 802 may be performed via a multitude of welding methods including, but not limited to, arc welding, gas welding, electric resistance welding, laser beam welding, electromagnetic pulse welding, and friction stir welding. Welding joins metals together by melting a filler material and the base metal. Welding material for the weld coating may include cobalt, nickel, tungsten, chromium, molybdenum, steel, and/or aluminum. In some embodiments, the weld coating may be coated onto the abutment face by some other bonding means. An example of a weld coating applied onto an abutment face of a shrouding is shown in FIG. 5.

In some embodiments, internal defects such as cracks or voids may exist between the weld coating and the abutment face. An example of such an embodiment can be seen by internal crack 480 in FIG. 5. In some embodiments, internal crack 480 may occur due to the dissimilar metals of the shrouded turbine blade and the weld coating 481. During operation of the shrouded turbine blade, the internal cracks in the abutment face can grow into the substrate. This may reduce the fatigue strength and lifetime of the shrouded turbine blade.

By applying hot isostatic pressing in Step 803, defects such as internal crack 480 of FIG. 5 can be healed. HIP subjects a component, such as a shrouded turbine blade, to the simultaneous application of high pressure (15,000 to 45,000 psi) and elevated temperature (up to 2500° C.) in a specially constructed vessel. In some embodiments, the HIP process subjects a component to a pressure between 15,000 to 35,000 psi, and a temperature between 800° C. to 2000° C. Furthermore, the HIP process may include a duration between 3 hours to 5 hours. The simultaneous application of heat and pressure over time may reduce porosity and internal voids in metals through a combination of plastic deformation, creep, and diffusion bonding. The pressure is usually applied with an inert gas such as argon, hence the term “isostatic”. Under these conditions of heat and pressure, internal pores or defects within a solid metal body collapse and diffusion bonding occurs at the interfaces. Encapsulated powder and sintered components can also be fully densified to improve mechanical properties and reduce the scatter band of properties. This may increase the density of the metal. Hot isostatic pressing may provide better control of grain growth as well as improve isotropic properties resulting in superior performance of the shrouded turbine blades. HIP may also improve fatigue life, impact toughness, creep rupture strength, and tensile ductility.

Some HIP systems may include a monolithic forged steel autoclave sealed by a threaded top closure in which the inert gas is pumped. Other HIP systems may include a multi-wall forged, relatively thin-walled vessels surrounded by tight fitting forged steel rings, or steel wire wound. In the steel wire wound system, the radial forces are taken up by a forged steel cylinder pre-stressed with high strength steel wire. The axial forces are transferred through the two moving closures to the external frame which is also pre-stressed with the wire winding. Pressure may be sealed within the vessel using Bridgman seals, metal-to-metal seals, single or double O-rings, or a combination of seals. The pre-stressing causes the pressure vessel wall to remain in residual compression even at maximum operating temperature, eliminating tensile loads, and preventing crack propagation and brittle failure.

The furnace of the HIP system may consist of resistance heater elements arranged in multiple, independently controlled zones. The choice of furnace and heater element materials may depend on the material being hot isostatic pressed and the temperature. For temperatures up to 1350° C., Fe—Cr—Al alloys may be used as heater elements. Molybdenum can be used in the temperature range 500-1600° C., and graphite for temperatures from 400 to 2200° C. or higher. For cooling, quench furnaces may be equipped with a forced convection system which circulates cooler gas through the work zone.

Machining in Step 804 may be performed to remove excess weld coating from the abutment face of the shrouding. Machining may remove any large weld beads that are left on the surface after welding in Step 803. Machining may result in a clean surface finish as shown by machined surface 482 in FIG. 7. Additionally, the rest of the shrouded turbine blade may be machined to final specifications and to remove any residual defects. In embodiments where the shrouded turbine blade is hot isostatic pressed after welding, the removal of porosity may improve the machined surface finish.

In some embodiments, a heat treatment process may occur after hot isostatic pressing in Step 803. The heat treatment process may alter physical and mechanical properties of the shrouded turbine blade without changing the shape. Furthermore, the heat treatment process involves heating the shrouded turbine blade to a suitable temperature, holding it at that temperature long enough to cause one or more constituents to enter into a solid solution, and then cooling it rapidly enough to hold these constituents in solution. Subsequent precipitation heat treatments allow controlled release of these constituents either naturally (at room temperature) or artificially (at higher temperatures).

In some embodiments, the method of manufacturing a shrouded turbine blade follows a sequential order of Step 801, Step 802, Step 803, and Step 804. Alternatively, the method of manufacturing a shrouded turbine blade follows a different order. In other embodiments, the method of manufacturing a shrouded turbine blade may not include all of the Steps 801-804. Additionally, the method of manufacturing a shrouded turbine blade may repeat one or more of the Steps 801-804. Alternatively, an embodiment including some or all of the Steps 801-804 may be used to manufacture other turbine components, such as non-shrouded turbine blades, turbine disks, turbine diaphragms, or turbine nozzles.

In some instances, the method above may be used to repair turbine blades. In such instances, the used turbine blade may be repaired by welding a coating of a different material than the used turbine blade onto a high wear surface of the used turbine blade, applying HIP to the high wear surface after welding the coating, and apply final machining after applying HIP. The high wear surface may include surfaces which undergo a large amount of friction during operation. The coating welded onto the high wear surface may provide a protective layer to resist the large amount of friction. Additionally, the HIP process may heal internal cracks that may form between the coating and the high wear surface. The final machining may remove any excess material of the coating.

In instances of prior methods where Step 802 occurs before Step 803, the internal defects formed in the abutment face and the coating may not be cured before machining in Step 804. Applying the HIP process in Step 803 after Step 802 may ensure internal defects between the coating and the abutment face are cured. In instances where Step 804 occurs before Step 803, internal cracks in the abutment face after welding may open up into the exterior surface of the abutment face after machining. This may result in an ineffective HIP process if there are externally exposed cracks.

The preceding detailed description is merely exemplary in nature and is not intended to limit the invention or the application and uses of the invention. The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method of manufacturing a shrouded turbine blade comprising:
casting a shrouded turbine blade including a shrouding, the shrouding including an abutment face;
welding a coating composed of a different material than a base material of the shrouded turbine blade onto the abutment face;
applying hot isostatic pressing to the shrouded turbine blade after welding the coating onto the abutment face, wherein the hot isostatic pressing is sufficient to heal internal defects in the abutment face; and
machining the shrouded turbine blade after applying hot isostatic pressing to the abutment face.

2. The method of claim 1, wherein the coating includes a material selected from the group consisting of: cobalt, nickel, tungsten, chromium, molybdenum, steel, and aluminum.

3. The method of claim 1, wherein the coating includes an exterior surface that is harder than the base material of the shrouded turbine blade.

4. The method of claim 1, wherein the internal defect is an internal crack located between the coating and the abutment face.

5. The method of claim 1, wherein the shrouded turbine blade is composed of a super alloy.

6. The method of claim 1, wherein the shrouded turbine blade has a reduced porosity and an increased density after hot isostatic pressing.

7. The method of claim 1, further including applying a heat treatment after applying hot isostatic pressing to the abutment face.

8. The method of claim 1, wherein the shrouded turbine blade is cast by a process selected from the group consisting of: die casting, investment casting, centrifugal casting, continuous casting, and permanent mold casting.

9. The method of claim 1, wherein the coating further includes an excess build up, and wherein the machining further includes removing the excess build up of the coating.

10. The method of claim 1, wherein the hot isostatic pressing includes a pressure between 15,000 to 35,000 psi, and a temperature between 800° C. to 2000° C.

11. A shrouded turbine blade manufactured by the method of claim 1.

12. A shrouded turbine blade comprising:
a blade platform;
an airfoil extending from the blade platform, the airfoil including a tip end distal from the blade platform;
a blade root extending from the blade platform;
a shrouding adjacent to the tip end of the airfoil, the shrouding including an abutment face; and
a coating welded and hot isostatically pressed to the abutment face of the shrouding.

13. The shrouded turbine blade of claim 12, wherein the coating includes a material selected from the group consisting of: cobalt, nickel, tungsten, chromium, molybdenum, steel, and aluminum.

14. The shrouded turbine blade of claim 12, wherein the shrouded turbine blade is composed of a super alloy.

15. The shrouded turbine blade of claim 12, wherein the shrouded turbine blade is machined after hot isostatic pressing.

16. The shrouded turbine blade of claim 12, wherein the abutment face has been heat treated after hot isostatic pressing.

17. The shrouded turbine blade of claim 12, wherein the shrouded turbine blade is casted by a process selected from the group consisting of: die casting, investment casting, centrifugal casting, continuous casting, and permanent mold casting.

18. The shrouded turbine blade of claim 12, wherein the coating further includes an excess build up, and wherein the machining further includes removing the excess build up of the coating.

19. The shrouded turbine blade of claim 12, wherein the hot isostatic pressing includes a pressure between 15,000 to 35,000 psi, and a temperature between 800° C. to 2000° C.

20. A method of manufacturing a shrouded turbine blade comprising:
casting a shrouded turbine blade including a shrouding, the shrouding including an abutment face;
applying a coating composed of a different material than the shrouded turbine blade onto the abutment face, the coating forming a hard exterior surface; and
applying hot isostatic pressing to the abutment face after welding the coating onto the abutment face, wherein the hot isostatic pressing is sufficient to heal internal defects in the abutment face.
